(19) United States
(12) Patent Application Publication
(10) Pub. No.: US 2008/0099624 A1
(43) Pub. Date: May 1, 2008

(54) Space tether transport system

(76) Inventor: Erik Evjenth, San Jose, CA (US)

Correspondence Address: Erik Evjenth, 3960 Timberline drive, San Jose, CA, 95121, US

(21) Appl. No.: 11/549,956

(22) Filed: Oct. 16, 2006

(51) Int. Cl. B64G 1/00

(52) U.S. Cl. 244/158.2

(57) ABSTRACT

A space transport system for transporting payloads between points on the ground, in the air, and in outer space, includes a tether wheels able to accept payload from the ground or a low, slow position and transport it at high velocity to either another low, slow location on the same planet, or to a high speed space trajectory.

### FIELD OF THE INVENTION

The invention relates in general to a system to deliver a payload from a planet either to escape velocity to another location on the planet with speed exceeding hypersonic transport.

### BACKGROUND OF THE INVENTION

Gravity has always been the man obstacle to space exploration, and it has always been a dream to escape, and explore space. The realization of this dream culminated in 1969 when man walked on the Moon. This technological triumph relied largely on big chemical rockets, and little payload. The cost to deliver a payload to orbit is prohibitive for almost all applications.

Separately, as transportation has improved dramatically in the previous century, it hit a wall with supersonic air transport, and successes in increasing speed or reduce cost have been limited.

New ideas for escaping gravity such as a space elevator have emerged, but are not feasible with today's technology.

Against this background of known technology, the inventor has devised a rotating tether that will deliver a payload vehicle with no or low velocity and deliver it with escape velocity away from a planet or to another location on the planet with speed exceeding hypersonic transport.

### RELATED ART

### SUMMARY OF THE INVENTION

Against this background of known technology, the inventor has devised a synchronized orbiting tether wheel that will deliver a payload vehicle with no or low velocity and deliver it with escape velocity away from a planet or to another location on the planet with speed exceeding hypersonic transport.

The basic principle is as simple as it is revolutionary. Imagine trying to jump into a car speeding down a highway at 30 m/s. This is impossible as the change in speed would probably kill you. A similar problem would arise trying to exit the speeding car.

Now, replace the car with a large Ferris wheel rolling down the highway at the same speed. As is rolls past you, the seat on the wheel right in front of you is stationary for a moment, and you can board, and sit down. You will instantly be thrown for a wild ride, and a short time later your seat again is on the ground, and you can exit while the seat is stationary on the ground for an instant.

In a preferred embodiment, replace this Ferris wheel with a 4000 km tether orbiting Earth. The tips of the tether “dip” into the atmosphere as the tether rolls around the earth. The rotation of the tether wheel is matched with its orbital speed so that the tips have little speed relative to the earth below. A payload “climbs” to the rendezvous location, catches the tip of the tether, and braces for the ride. At the top of the wheel, the payload is traveling above escape velocity and can disconnect to continue on a trajectory away from earth. The payload may also continue for the whole ride, and disconnect at the next low speed dip into the atmosphere.

The payload may of course also be accepted at the top of the wheel to deorbit delivering excess energy to the wheel.

The overall orbital energy of the wheel can be managed both by accepting and delivering payload, as well as using various impulse engines.

On planets with little atmosphere, like Mars, the tether tip could potentially reach close to the ground for direct orbital pickup.

An embodiment with more wheels, on rolling around Earth, one rolling around Mars, and possible in space for payload orbital modification. This could allow frequent transport from Earth to Mars and back with almost no energy consumption except atmospheric friction.

### BRIEF DESCRIPTION OF THE DRAWINGS

The above aspects of the invention and others will be better appreciated after a reading and understanding of the detailed description of the invention that appears below together with the following drawings wherein:

FIG. 1 is a planetary scale view from North looking at the tether wheel rolling along the equator. Trajectories of select payloads are drawn to illustrate.

FIG. 2 is a planetary scale view from North looking at a tether wheel with a different constellation than the one illustrated in FIG. 3. Trajectories of select payloads are drawn to illustrate.

FIG. 3 is a view of an example tether configuration dynamically kept in place with breaking climbers.

FIG. 5 is a view of a transport system between two planets using tether wheels, drawing not to scale.

FIG. 6 is a view of a tether with an example configuration of a solar power array powering impulse engines on a payload vehicle.

FIG. 7 is a view of a planet orbiting tether wheel delivering a payload to a large space based tether wheel for large velocity change.

FIG. 8 is a view of a transport system between two planets including mass drivers installed on two types of bodies capable of delivering appropriate mass to the tethers for energy management.

### DETAILED DESCRIPTION OF THE PREFERRED EMBODIMENTS

The following description is provided to enable any person skilled in the art to make and use the invention, and sets forth the best modes contemplated by the inventor of carrying out his invention.

Variations, however, may be readily apparent to those skilled in the art, since only the generic principles of the present invention have been defined herein specifically to provide teachings for a “synchronized orbiting tether wheel” apparatus useful in transporting material and personnel from the earth's surface into orbit.

This transport system needs other systems for support mainly for orbital management. There are many uses for this transport system, and each use has its own logistics.

The criteria for selecting the parameters for the tether wheel is partly the load the transport system expose the payload to. The load, measured here in g is equivalent to 9.81 ms⁻². For a planet like Earth, a 4000 km tether can be used. This will expose the load to 2.75 g at pickup, and 1.39 g at apex, and is quite within what is acceptable for humans.

### The Use of the Tether Wheel

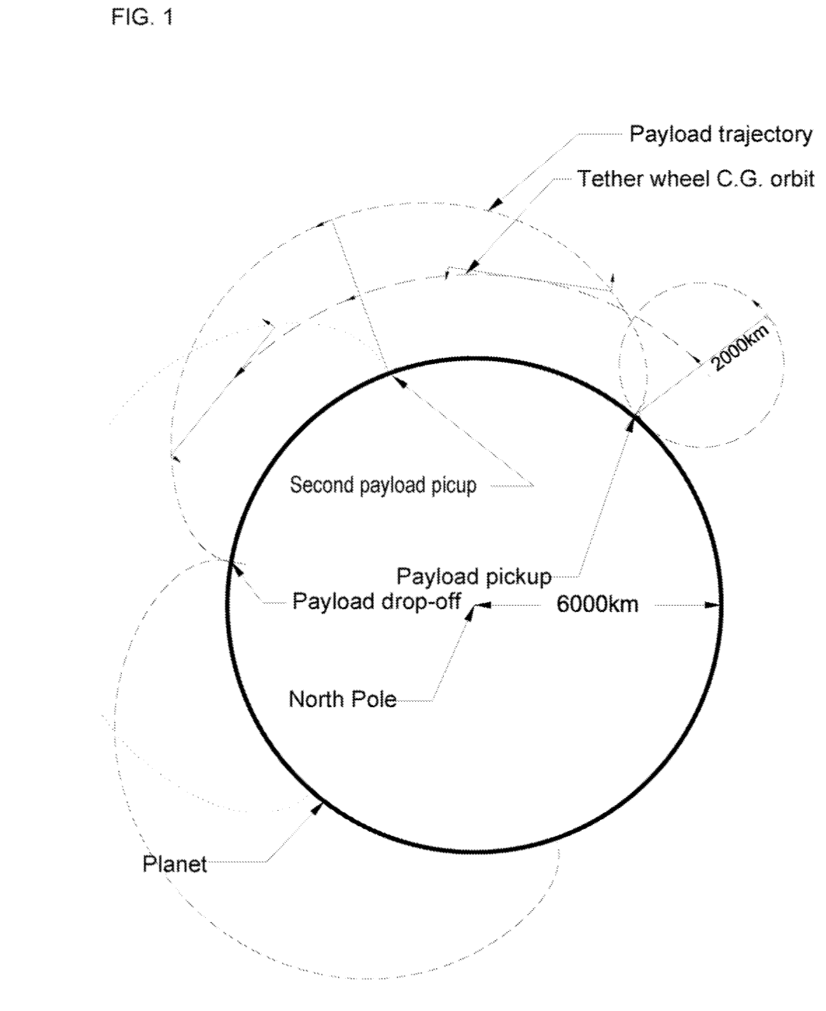

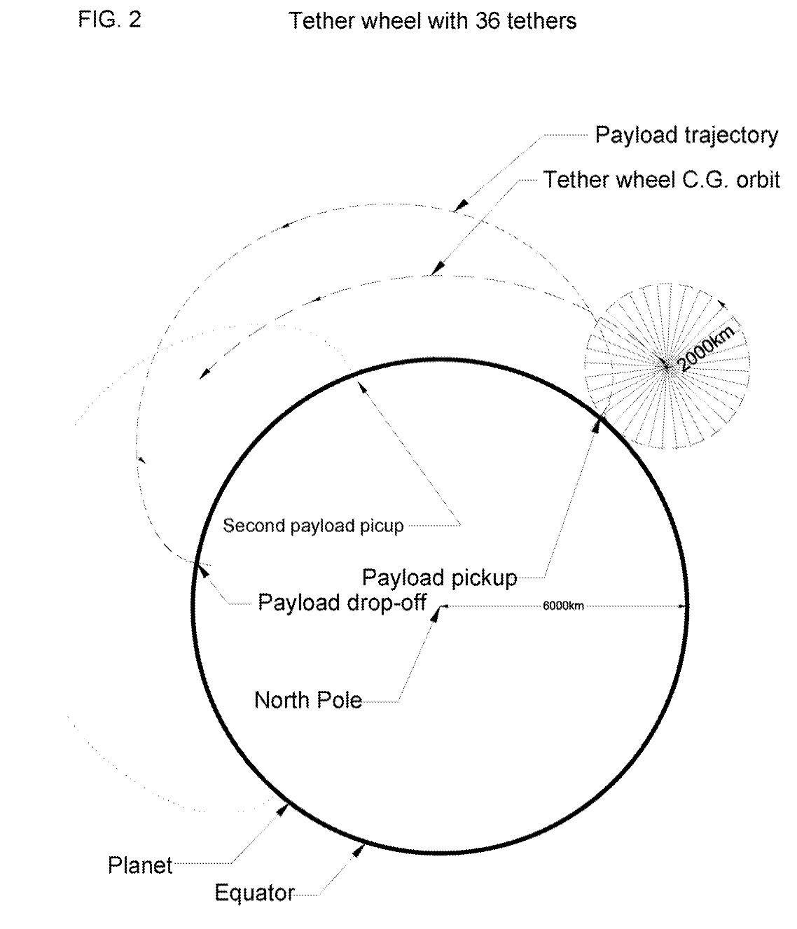

Referring now to FIG. 1, the synchronized orbiting tether wheel is a satellite orbiting the planet 2040 km above the earth. The satellite is a rotating tether wheel with two arms. The tip of these arms “dips” into the atmosphere as the tether rolls or orbits around the earth. How far into the atmosphere these tips will go is a tradeoff between the payload delivery technology and energy management of the orbiting wheel, since atmospheric friction reduces the energy of the system. With little planetary atmosphere, the tips can go almost to the ground, only limited by orbital energy management and ground topology.

On a planet with no atmosphere, the delivery system would typically be compromised of a ground based launch pad with a stationary payload vehicle. Assuming orbital management restrictions and topography of the planet, allowed, the tips of the tether wheel dips down to 100 m above the launch pad.

On a planet like Earth, to reduce energy consumption of the system, the payload vehicle should be brought as high as possible. A special purpose high altitude aircraft could be used for this. A balloon or ground based tether could all be used to deliver the payload vehicle to the tether wheel as well.

In one embodiment, a short tether is shot up from the payload vehicle, and it connects with the tether descending from the tether wheel. Note that although the tether wheel is orbiting at high speed, the tip will have no speed relative to the payload vehicle as it reaches the bottom of its trajectory.

Another embodiment, the tether has a retractable tip that typically can be controlled more or less automatically by remote control by the payload operator

Still referring to FIG. 1, the payload now will follow an epicycloid orbit, and dip into the atmosphere about 30 minutes later, 13000 km away. The payload vehicle disconnects, and flies in for a landing, possible on the back of the aircraft that just released a second payload to the tether wheel.

The experience for a passenger: The trip starts in Singapore. The departure is like any departure in a jet from an airport. The jet carrying the vehicle climbs to 40 km, where the vehicle immediately connects to the tether. The passenger g load goes from 1 g to 3.3 g in about 10 seconds as the tether stretches and pulls. The g-load on the passenger drops down to a 1 g as the passenger passes over the top and then back up to 3.3 g before release over the next 30 minutes. Then it is gradually again reduced to 1 g as the vehicle glides, and lands in Panama

If the payload vehicle is traveling away from the planet, the vehicle releases from the tether wheel at the apex of the trajectory. It will have a velocity far exceeding escape velocity.

Fuel economy is exceptional, both for high escape velocity missions, de-orbit and landing, as well as a hypersonic transport system. Transpacific transport in 30 minutes on a few kWh per passenger should allow for a very competitive system.

### The Physics of the Tether Wheel

This section contains many approximations and excludes certain relevant considerations such as safety margins, for the purpose of clarity and simplicity. It is certainly more than accurate enough to demonstrate feasibility, as well as what is needed to actually build the wheel, as orbital parameters are adjustable as the construction proceeds.

A planet with parameters similar to Earth is shown in FIG. 1.

First, tensile strength is paramount for the construction of this invention. If the payload is 1000 kg, and with a 7 GPa usable strength carbon fiber with density of 1750 kgm⁻³, the tether will weigh about 3000 tons. If the tensile strength is reduced to 4 GPa, the tether will weigh in at over 400000 tons. However, with only 4 GPa, a 2000 km tether would only weigh 65000 tons. The ratio between payload and tether wheel weight is proportional, and other weight ratios are given in table FIG. 10.

Table FIG. 10. Weight ratio Total Tether weight relative to payload weight with different material strengths.

Note that this is for one tether. A wheel will need either two tethers or some other counterweight arrangement.

Table 1 was calculated with the following considerations.

Planet radius, rₚ=6000 km, tether radius, rₜ=2000 km, and tether center of gravity orbit, rₒ=8040 km, and planet rotational velocity at equator, vₚ=500 ms⁻¹. The wheel rolls in the same direction as the planet rotates.

The orbital speed for a satellite at rₒ is vₒ=6363 ms⁻¹ so the rotational speed of the tether tips must be vₜ=vₒ−vₚ=5864 ms⁻¹.

Considering the bottom the wheel at the bottom of the wheel we have: Acceleration of a point on a rotating body given speed v, and distance from axis of rotation is given in FIG. 11, and with g=−9.81 ms⁻², we get centrifugal acceleration aₜ=−2.06. Further gravity is −1 g, and since the whole tether is orbiting earth, we will at r=6040 km experience aₒ=0.39 g, so total acceleration is aₜ=−2.66 g. at other distances, gravity is given by FIG. 12, so at the top of the trajectory we have centrifugal acceleration aₜ=2.06 g. Further gravity is −0.36 g, and since the whole tether is orbiting earth, we will at r=10040 km experience aₒ=0.64 g, so total acceleration is aₜ=2.34 g.

To calculate total weight we simply start with the desired payload, and integrate these loads over the length of the tether while the tether is in the vertical position since this is the highest stress orientation.

Note from Table 1, that a shorter tether weighs much less than a big tether. The overall energy delivered to a payload is similar. The challenges with a smaller tether wheel is firstly, that the g-load on the payload increases with smaller wheels, and secondly, that there is less time with little relative velocity when the payload is attached or detached. Atmospheric friction also increases with smaller tether wheel.

### The Support System.

The support system requirements depend on the use of the wheel. The simplest case, with no atmosphere, and only transport on the surface, the transport is basically fast and almost free. The energy stored in the wheel due to elastic stretching may be lost upon release of payload. This must be minimized, both due to energy loss, as well as geometry distortion. One solution is of course to always keep the payload on. When one is released, another is immediately attached.

This tether wheel could easily run for decades with normal satellite energy management techniques.

With atmosphere, it is important that the atmospheric friction is minimized. The tether will descend and ascend vertically through the atmosphere with little resistance. The tip, with payload, starting with no speed at 40 km, will accelerate straight up. After 67 s, at an altitude of 100 km, the speed is 1267 ms⁻¹. There is very little atmosphere above 40 km, and the speed of the payload is subsonic up to about 50 km.

FIG. 13 Table. Typical atmosphere data, and simplified resulting drag on a smooth sphere, diameter=2 m, picked up at 30 kilometers.

The table is calculated with the constellation shown in FIG. 1. Note that with velocity and force, the drag induced energy loss can be extrapolated.

The vehicle is unlikely to be a smooth sphere, but represents a very simplified model for a possible payload. This is to show feasibility, and assist a person skilled in the art to understand how to construct this invention. So, with a smooth sphere d=2 m, peak drag will be 44N at 48 km altitude. Total energy lost to friction is 18 MJ or 6 kWh.

If pickup altitude is reduced to 30 km, energy loss is 30 kWh with 180N drag at 38 km, and at 20 km loss is 150 kWh with 900N drag at 28 km.

Due to elasticity, the actual numbers are better than this.

Further, the tether will stay tight as long as terminal velocity is higher than tether velocity on decent. This limitation makes it difficult to get the tip lower than 10 km. Further, with a pickup at 10 km altitude, the aerodynamic load on the payload would exceed 4000N at 18 km. This would require many thousand tons of increased tether weight.

The conclusion is that the delivery point should be as high as feasible.

### Energy Management

One great advantage of this wheel over a traditional rocket is that the wheel can build up energy over time using very high specific impulse engines, for later to deliver this back to the payload vehicle in a short time.

Two fundamentally different methods exist to replenish the energy of the wheel.

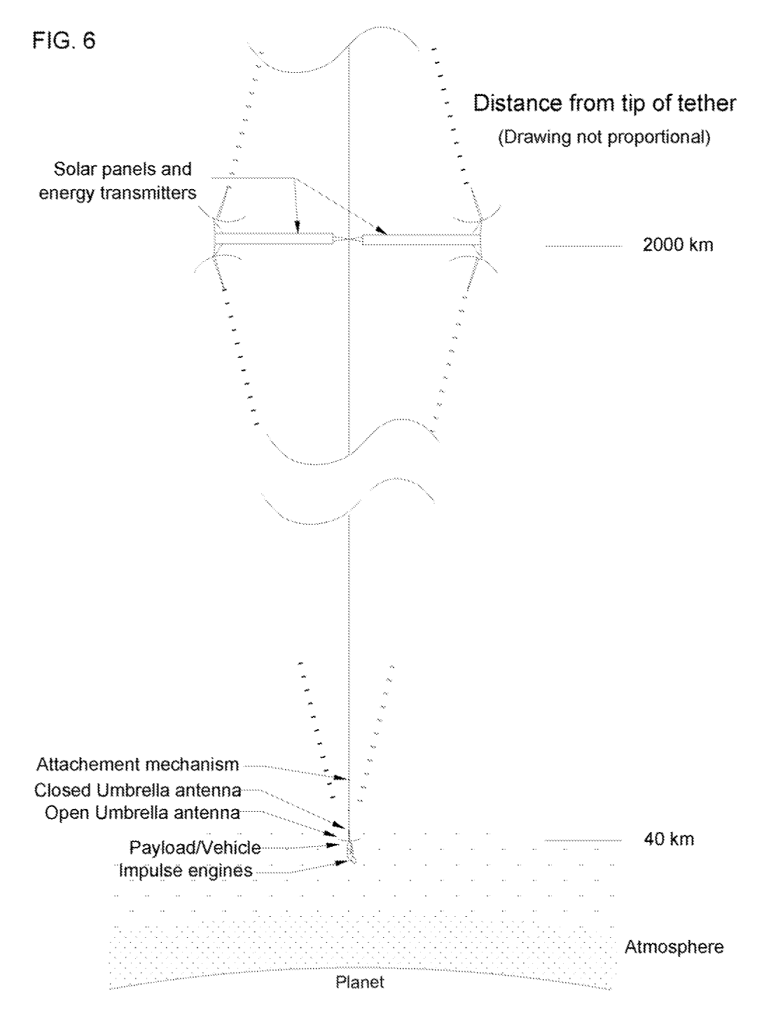

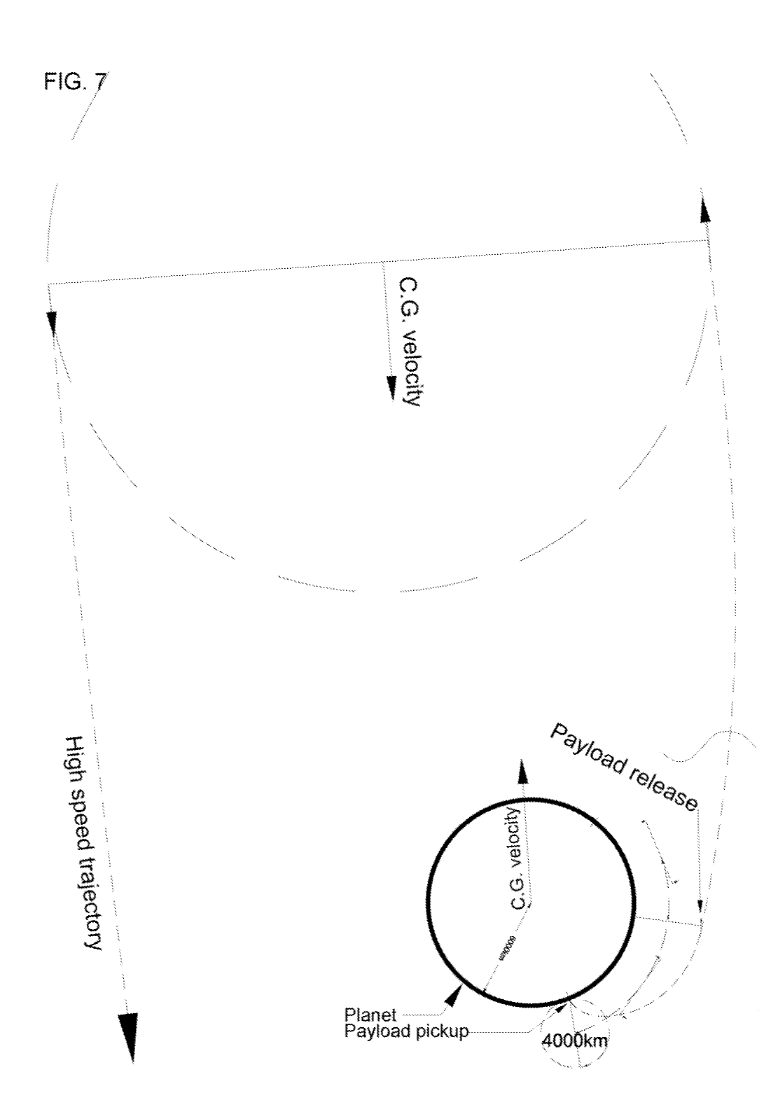

A preferred embodiment is depicted in FIG. 6. This would be a special payload vehicle with impulse engines, and an antenna. A solar array in the center of the wheel would deliver RF energy to the impulse engines. The vehicle could simply suck in some atmosphere at antipex, or use a more suitable material, and fire the engines for the first half of the loop.

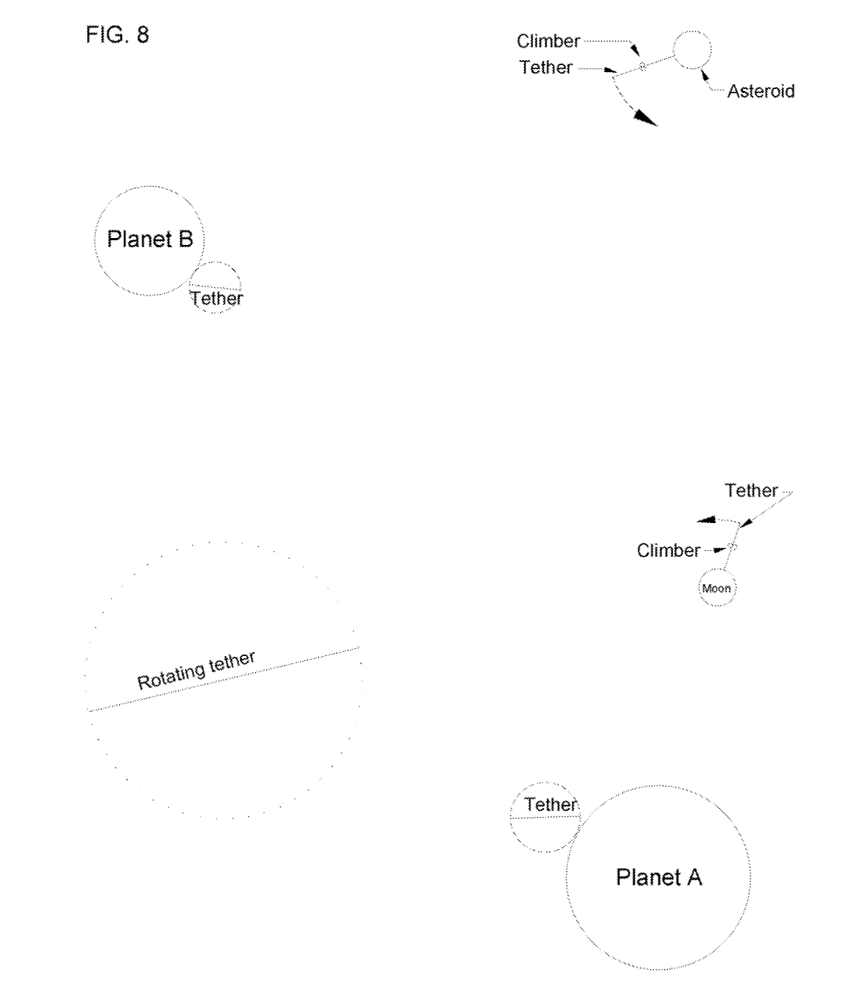

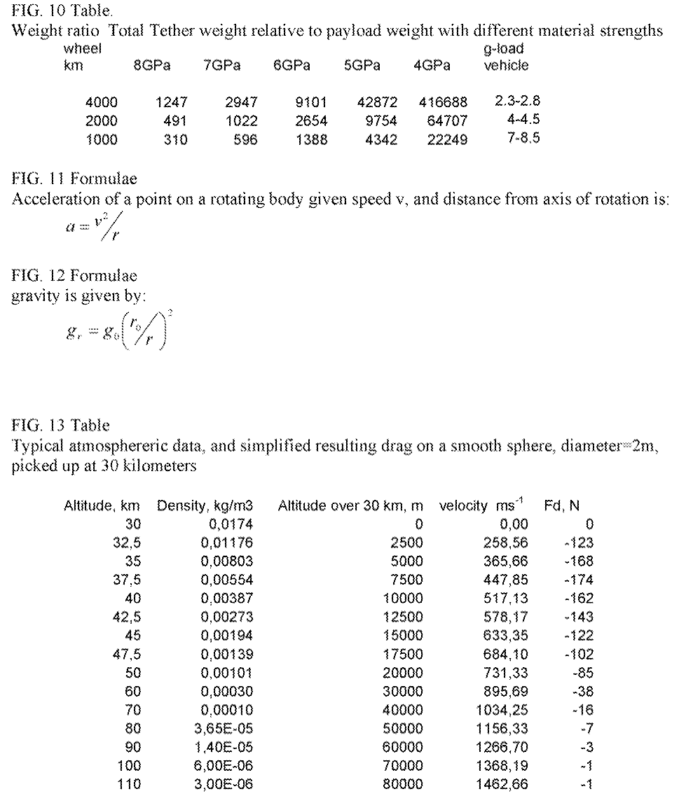

Another embodiment is depicted in FIG. 8. Mass is thrown at the wheels from nearby bodies. The tether wheel catch the mass at apex, and carries it to antapex, and releases it. This will add significant energy to the wheel orbit.

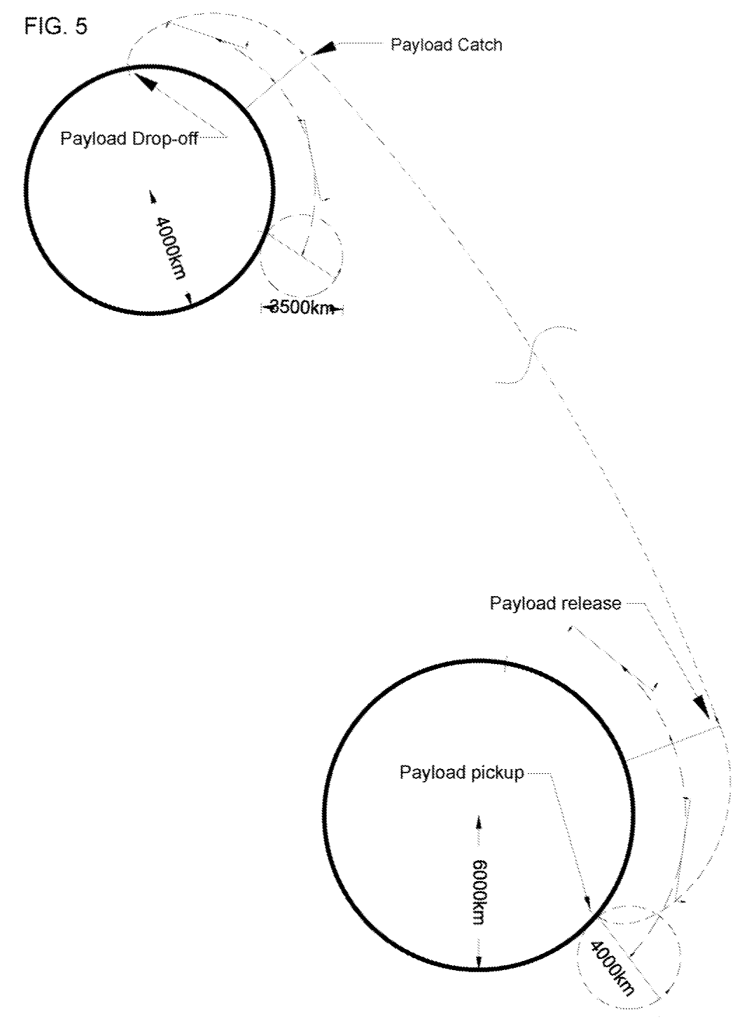

Another embodiment is depicted in FIG. 5; two wheels are orbiting two planets. This represents a particularly good implementation. The system is a shuttle service between the two planets, say Earth and Mars. With planets like Earth and Mars, the wheel could orbit Mars in a retrograde way, as well as have different diameter. These constellation choices can allow a good match in velocities of the wheels. The vehicle connects to the tether on earth, and disconnects close to apex. The trajectory takes it to Mars, where it catches the wheel again near apex, and is deposited directly onto the Martian surface. Another vehicle is picket up from Mars, and disconnects from the wheel near apex, and travels to Earth, connects at apex, and disconnects at antapex, and glides to the ground. The total energy consumption for the spaceflight is a few hundred kWh. A perfect match up between two planets like this is of course not very likely, and at best only possible at certain planetary constellations so the vehicle probably has to perform orbital adjustments.

A combination of the two embodiments above is for many constellations the best choice.

In the case illustrated in FIG. 1, if the vehicle travels from a planet with no return or reciprocity, the wheel looses a lot of energy. The potential energy at the surface of the Earth is −62.6 MJ/kg, and at the apex, the potential energy is −60 MJ/kg. Kinetic energy at 12 kms⁻¹ is 75 MJ/kg.

In the case illustrated in FIG. 1, a 1 ton vehicle will be lifted 4000 km up, and given a speed of 12 kms⁻¹. This will drain the wheel of 77 GJ. The average orbital radius would be reduced with 500 m. A heavier vehicle would require a correspondingly heavier wheel, with no difference in orbital change. A stronger, lighter wheel would of course see bigger orbital changes. A slightly elliptic orbit should therefore be kept, or at least built up before a one-way lift, so the wheel would not “plow” too deep into the atmosphere.

The payloads add little angular momentum to the wheel itself, as all loads are radial. If the wheels rotation becomes a little bit out of synch with its orbital velocity, the tips reaching into the atmosphere will have a horizontal component, and see a drag that will tend to stabilize the wheel synchronization, just like a wheel rolling on the ground will, due to friction, roll without slipping.

### Elastic Control and Oscillations

A carbon fiber may stretch 2%. As the payload is picked up, the 2000 km tether stretches. Since most of the load is the tether itself, the stretching decays exponentially towards the center of the wheel. The tip however should not be allowed to recoil too much. Keeping the wheel loaded at all times is the best way to manage this. Other embodiments include spooling the short payload attached tether in and out to dampen the oscillations or using an impulse engine.

The wheel rotates in a gravitational field. This field varies considerably over the size of the wheel. To minimize or eliminate oscillations, the diameter of the wheel must be selected to avoid possible resonances. Payloads and impulse engines on payloads could also be used for this purpose if necessary. This would be modeled accurately as part of construction.

### Payload Delivery

On planets with no atmosphere, the wheel can pick up the payload right from the ground. With an orbit slightly elliptic, and with pickup at perihelion, no tether tip will interfere with ground away from the launch pad, and the wheel can absorb bigger lifts without the tips plowing into the ground.

On planets with an atmosphere, orbital considerations are similar. A special, high altitude aircraft can be used to deliver the payload to the wheel. A balloon can also be used.

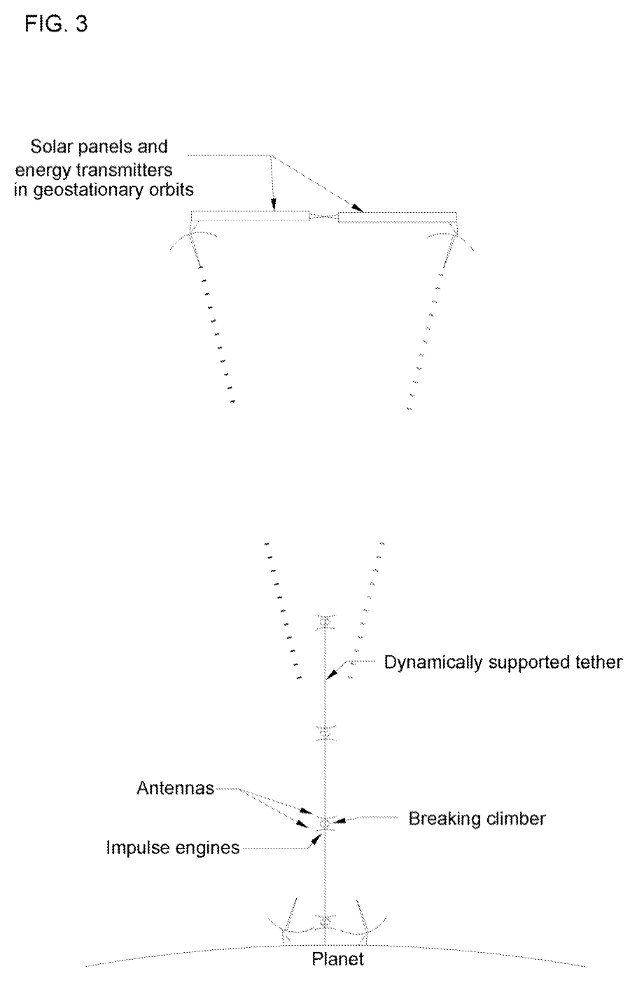

Another embodiment of a payload delivery is a ground attached tether seen in FIG. 3. Attempts to build space elevators on earth have failed because not material has been found with high enough tensile strength. A tether can be built with a breaking climber. This is a climber with an impulse engine. The impulse engine is pushing the climber upwards while it is breaking. This keeps the tether upright dynamically. The climber may get RF energy from a ground or space based source, and may carry and/or collect the mass used. The climber can revert to a regular climber when an altitude sufficient to allow a static tether to be constructed with current materials. On earth it would not be necessary to build the tether that high for payload delivery to a wheel. This embodiment may also be used to support other tether constellations for example for the mass drives shown in FIG. 8. This would include vectored thrust for positioning.

### Maintenance and Other

Due to its simplicity, this system can operate for very long time with little maintenance. Some special payload vehicles as well as tether climbers can be used to strengthen and perform various upgrades on parts of the wheel. This may also include moving a wheel from one planet to another. A combination of solar impulse engines, mass driver, and chemical impulse engines may be used.

### Safety

This transport system is inherently very safe compared to any current system. 1. there are no flammable propellant in the vicinity of the payload. 2. There are no volatile chemicals burning 3. There is no high speed atmospheric entry or exit. 4. There are little aerodynamic loads on the system. 5. The mechanical design is truly simple.

It should be feasible to achieve the same reliability as current commercial aircraft systems. This is many orders of magnitude better than any current system. It should also therefore compete well with commercial airlines on long flights.

The present invention has been described in terms of several preferred embodiments, it being understood that numerous obvious additions and modifications to these embodiments will become apparent to those skilled in the relevant arts upon a reading and understanding of the foregoing disclosure. The wheels have had almost circular orbits close to the equator, and the wheel and planet have had the same plane of rotation. There are truly many degrees of freedom to an embodiment of this invention. Examples include wheels that have pickup points away from the equator, wheels that have highly elliptical orbits, as well as wheels that does not orbit around the planet it “touches”, such as a solar orbit, or even a solar retrograde orbit. The wheel could also stay away from planets altogether, and just do trajectory and velocity changes like the big wheel illustrated in FIG. 8. This would actually be a required part of many planet to planet shuttles. It is intended that all such obvious modifications and improvements be included within the coverage of this patent to the extent that they fall within the scope of the several claims appended hereto.

I claim:

1. A space tether transport system for transporting payloads between points on the ground, in the air, and in outer space, compromising:
an orbiting rotating tether wheel with mechanisms for accepting and releasing payload at the perimeter tips at low speed close to the planet surface, as well as at high speed far from the planet surface,
a system delivering and receiving payloads to the tether close to the planet surface,
a system delivering orbital energy to the tether wheel with using impulse engines
a system delivering orbital energy to the tether wheel using remote mass drivers
a system of tether wheels orbiting multiple planets and in other orbits completing an interplanetary transport system

2. The space tether system in claim 1, wherein the system consists of only orbiting rotating tether wheel or wheels with mechanisms for accepting and releasing payload at the perimeter tips at low speed close to the planet surface, as well as at high speed far from the planet surface.

3. The tether wheel in claim 2, wherein the wheel orbits a planet with atmosphere, and the tether wheel tips dips into the atmosphere low and slow with little horizontal velocity.

4. The tether wheel in claim 2, wherein the wheel orbits a planet with atmosphere, and the tether wheel tips do not dip into the atmosphere, but goes low and slow.

5. The tether wheel in claim 2, wherein the tether wheel consists of a tether connecting two tips only.

6. The tether wheel in claim 2, wherein the payload is connected to the tether using an intermediary tether between the payload and the tether tip.

7. The tether wheel in claim 2, wherein maintenance as well as transport to the wheel hub is performed by tether friction climbers.

8. The tether wheel in claim 2, wherein stability and energy management is performed by a payload vehicle with impulse engines.

9. The tether wheel in claim 8, wherein the tether wheel includes a solar power system able to beam energy to the payload vehicle with impulse engines.

10. The tether wheel in claim 9, wherein the impulse engines sucks up mass from the atmosphere at antapex, and using energy from the solar power system, can operate over extended periods.

11. The tether wheel in claim 7, wherein the climbing vehicles uses energy beamed to it.

12. The transport system of claim 1, wherein the remote mass drivers are ground based tethers, where ground can be on any body present in the solar system.

13. A dynamic ground based tether supported dynamically close to the ground using breaking climbers, and supported statically at high altitude, supporting same climbers.

14. The ground based tether in claim 13, wherein the climbers are powered by electromagnetic radiation beamed to the climber.

15. A tether wheel that does not come close to planets or other bodies for direct payload pickup, but that is instead used for modification of trajectory velocity of payload vehicles.
